(19) United States
(12) Patent Application Publication
(10) Pub. No.: US 2010/0138857 A1
(43) Pub. Date: Jun. 3, 2010

(54) SYSTEMS AND METHODS FOR PROCESSING DATA PACKETS

(75) Inventor: Shraddha Gondkar, Richardson, TX (US)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 12/326,425

(22) Filed: Dec. 2, 2008

(51) Int. Cl. H04N 7/167; H04N 7/16

(52) U.S. Cl. 725/31; 725/151

(57) ABSTRACT

Integrated circuits (290, 252, 254) and methods (500) for processing transport stream signals (240₁, 240₂, 240₃, . . . , 240_{N}) including broadcast program data packets (226₁, 226₂, 226₃, . . . , 226_{N}) containing broadcast program data and non-broadcast program data packets (318) containing non-broadcast program data. The methods involve (518) multiplexing a portion of the non-broadcast program data packets together to form a first signal (224). The methods also involve (522) processing the first signal to generate a second signal (228). This processing includes re-encrypting a portion of the non-broadcast program data to form re-encrypted non-broadcast program data. The methods further involve (524) demultiplexing the second signal to obtain at least one data packet (422₁, 422₂, 422₃, . . . , 422_{N}) therefrom including the re-encrypted non-broadcast program data. Thereafter, (528) the data packet and the broadcast program data packet(s) are multiplexed together to form multiplexed packet(s).

### BACKGROUND

1. Statement of the Technical Field

The present invention relates to packet-based communication systems. More particularly, the present invention relates to packet-based communication systems implementing methods for re-multiplexing decrypted transport packets.

2. Description of the Related Art

Digital television set-top boxes (STBs) or set-top units (STUs) are devices that connect to display devices (e.g., televisions and computing devices) and external sources of transport streams. The transport streams can include broadcast program data packets containing broadcast program data. The transport streams can also include non-broadcast program data packets containing non-broadcast program data and/or encrypted non-broadcast program data. The STBs/STUs are generally configured to process the transport streams for obtaining content which is then displayed on the display devices.

During operation of an STB/STU, each of the transport streams is processed for obtaining the broadcast program data packets and the non-broadcast program data packets therefrom. The broadcast program data packets are sent to a first transport packet parser for temporary storage and subsequent processing to obtain content that is to be displayed on a display device. The non-broadcast program data packets are sent to a multi-stream bi-directional cable card (e.g., an “M-card”) for decryption of the data contained therein and re-encryption of the decrypted data using an encryption key that is unique to the STB/STU. Subsequent to re-encrypting the data, the non-broadcast program data packets are sent to a second transport packet parser for temporary storage and subsequent processing to obtain content that is displayed on the display device. The above described multi-transport packet parser configuration provides an STB/STU implementing a data processing method that is computationally inefficient and hardware intensive.

### SUMMARY

This summary is provided to comply with 37 C.F.R. §1.73, presenting a summary of the invention briefly indicating the nature and substance of the invention. It is submitted with the understanding that it will not be used to interpret or limit the scope or meaning of the claims.

One embodiment of the present invention concern systems and methods for processing a plurality of transport streams. The transport streams include broadcast program data packets containing broadcast program data and non-broadcast program data packets comprising non-broadcast program data. The methods involve multiplexing at least a portion of the non-broadcast program data packets together to form a first signal. The first signal is processed to generate a second signal including re-encrypted non-broadcast program data. The methods further involve demultiplexing the second signal to obtain at least one data packet therefrom including the re-encrypted non-broadcast program data and multiplexing the data packet and at least one of the broadcast program data packets together to form at least one multiplexed packet.

Another embodiment of the present invention comprises integrated circuits (ICs) comprising a substrate having a semiconductor surface. The IC comprises a first multiplexer, a demultiplexer, and a second multiplexer. The first multiplexer is disposed on the substrate. The first multiplexer is configured for multiplexing at least a portion of the non-broadcast program data packets together to form a first signal. The demultiplexer is disposed on the substrate and demultiplexes a second signal including the non-broadcast program data that has been re-encrypted to obtain at least one data packet therefrom. The second multiplexer is coupled to the demultiplexer and disposed on the substrate. The second multiplexer is configured for multiplexing the data packet and at least one of the broadcast program data packets together to form at least one multiplexed packet.

### BRIEF DESCRIPTION OF THE DRAWINGS

FIG. 1 is a block diagram of a packet-based communication system according to an embodiment of the present invention.

FIG. 2A is a more detailed block diagram of the set top box shown in FIG. 1 comprising a multiplexer and a demultiplexer according to an embodiment of the present invention.

FIG. 2B is a block diagram of a package having at least two integrated circuits therein according to an embodiment of the present invention.

FIG. 3 is a more detailed block diagram of the multiplexer of FIG. 2A according to an embodiment of the present invention.

FIG. 4 is a more detailed block diagram of the demultiplexer of FIG. 2A according to an embodiment of the present invention.

FIGS. 5A-5C collectively provide a flow diagram of an example of a method for processing data packets according to an embodiment of the present invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

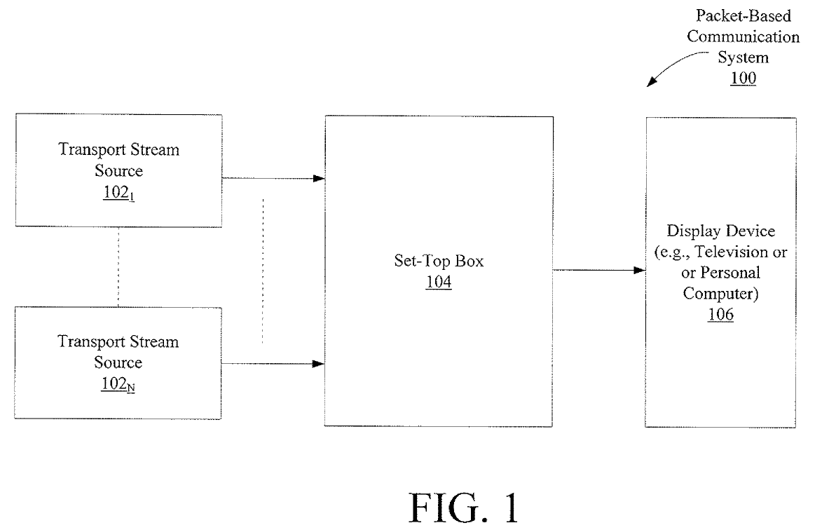

Embodiments of the present invention will now be described with respect to FIGS. 1-5C. Embodiments of the present invention relate to systems and methods for processing packets. The methods generally involve receiving a plurality of transport streams at a packet processing device. The methods also involve parsing each of the transport streams into a plurality of component parts that are defined by broadcast program data packets and non-broadcast program data packets containing encrypted data. The methods also involve processing the non-broadcast program data packets to re-encrypt the data contained therein. The methods further involve re-multiplexing the broadcast program data packets with the non-broadcast program data packets including the re-encrypted data prior to subjecting the same to transport processing.

Notably, embodiments of the present invention overcome certain drawbacks of conventional STBs/STUs. For example, embodiments of the present invention use a single processing pipeline (or a Transport Packet Parser) instead of multiple processing pipelines (or Transport Packet Parsers). This reduced processing pipeline configuration improves an overall efficiency of a packet processing device (e.g., an STB/STU) design as well as reduces the hardware logic thereof. As such, embodiments of the present invention are less hardware intensive than conventional STBs/STUs. Embodiments of the present invention are also relatively computationally efficient as compared to conventional STBs/STUs.

The system, method and apparatus desired herein, may be utilized in any application where data packets need to be processed. Such applications include, but are not limited to, television applications, computer applications, packet-based electronic communication applications, and packet-based optical communication applications. Accordingly, the system, apparatus and method will now be described generally in relation to one such application, namely the television application (and more broadly the packet-based electronic communication application).

The word “example” is used herein to mean serving as an instance or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

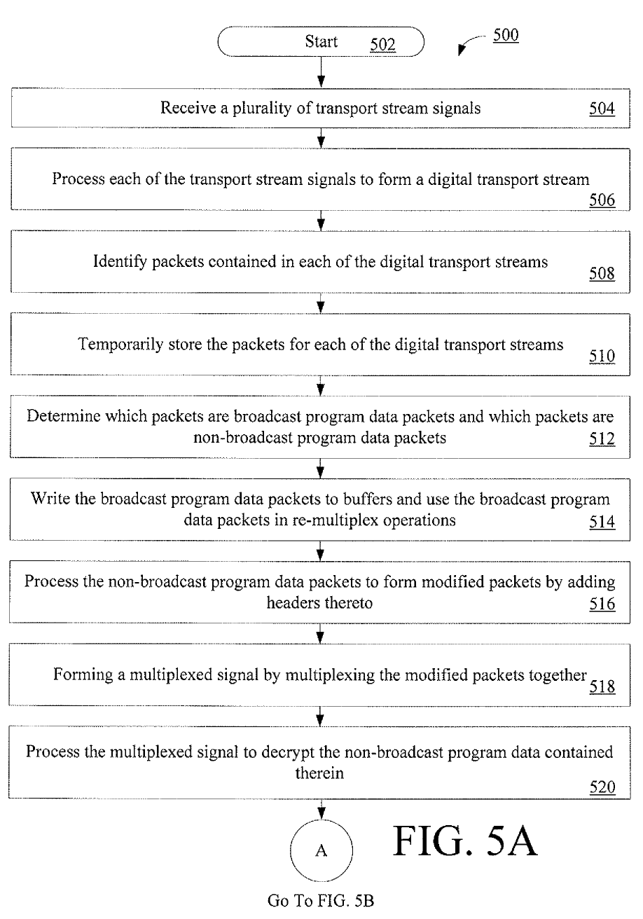

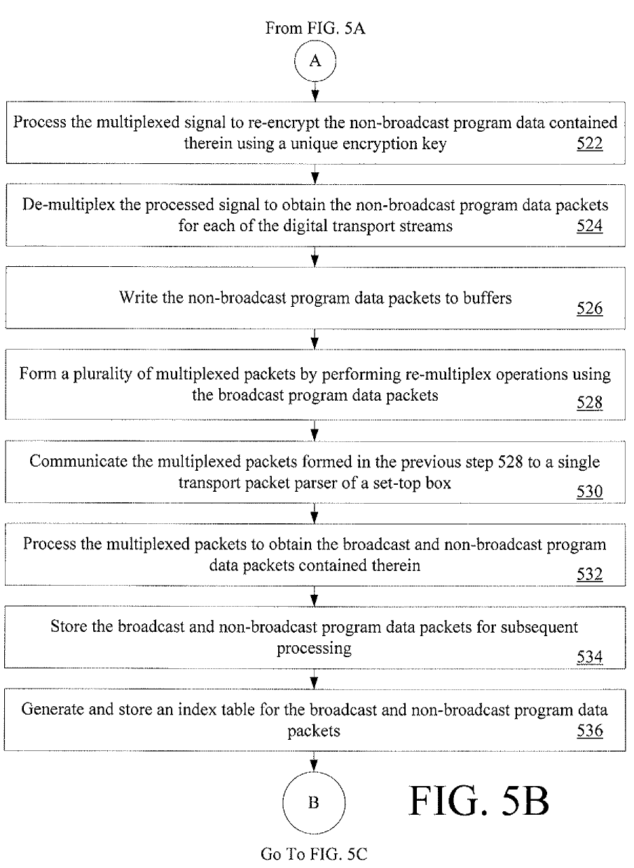

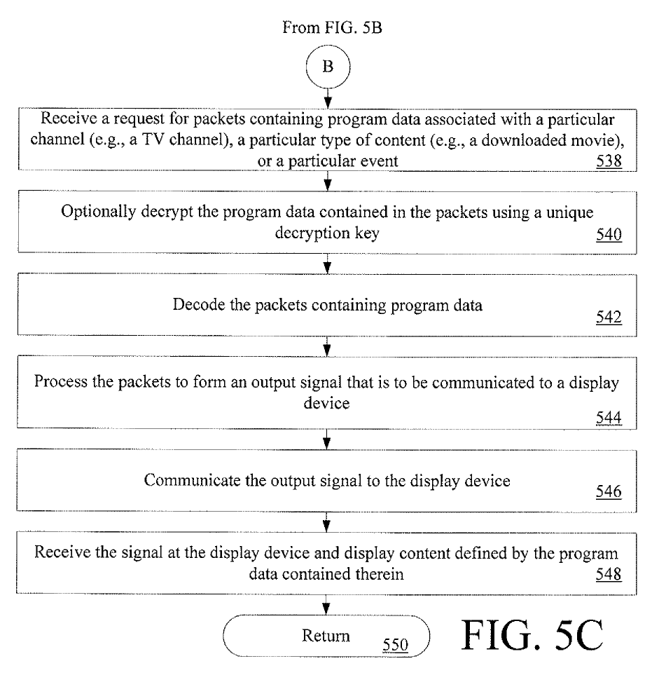

Referring now to FIG. 1, there is provided a packet-based communication system 100 according to an embodiment of the present invention. The packet-based communication system 100 can be an electronic (wired or wireless) communication system or an optical communication system. The configuration of system 100 is generally similar to the configuration of a conventional packet-based communication system 100. However, the system 100 includes a packet processing device 104 (shown as an STB in FIG. 1) that implements a new method for processing packets according to an embodiment of the present invention. This method for processing packets will be described below in relation to FIGS. 5A-5C.

As shown in FIG. 1, the system 100 includes a plurality of transport stream (TS) sources 102₁, . . . , 102_{N}, an STB 104, and a display device 106. Each of the TS sources 102₁, . . . , 102_{N} is communicatively coupled to the STB 104. This coupling can be provided by an Ethernet cable, a satellite dish, a coaxial cable, a telephone line, a Broadband over Power Line, an antenna, and/or any other suitable coupling means known to those having ordinary skill in the art. Each of the TS sources 102₁, . . . , 102_{N} is configured to generate a transport stream containing a plurality of packets. The packets can generally include broadcast program data packets and non-broadcast program data packets. The broadcast program data packets can contain broadcast program data (e.g., data defining content for a public television channel). The non-broadcast program data packets can contain encrypted non-broadcast program data (e.g., data defining content for a non-public television channel such as the Home Box Office (HBO®) channel).

The STB 104 is generally configured to receive and process the transport streams from the TS sources 102₁, . . . , 102_{N}. In particular, the STB 104 is configured to process the transport streams for obtaining the broadcast program data packets and the non-broadcast program data packets therefrom. The STB 104 is also configured to temporarily store the broadcast program data packets for use in at least one subsequent re-multiplex operation. The STB 104 is further configured to decrypt the data contained in the non-broadcast program data packets and re-encrypt the decrypted data using an encryption key that is unique to the STB 104. Thereafter, the non-broadcast program data packets are temporary stored for use in subsequent re-multiplex operations. The broadcast program data packets and the non-broadcast program data are multiplexed together to form one or more multiplexed signals. The multiplexed signals can be subsequently processed to obtain content that is subsequently displayed on the display device 106. The display device 106 can include, but is not limited to, a television and a computer monitor of a desktop personal computer system, a laptop personal computer system, a personal digital assistant, a wireless computing device, or any other general purpose computer processing device.

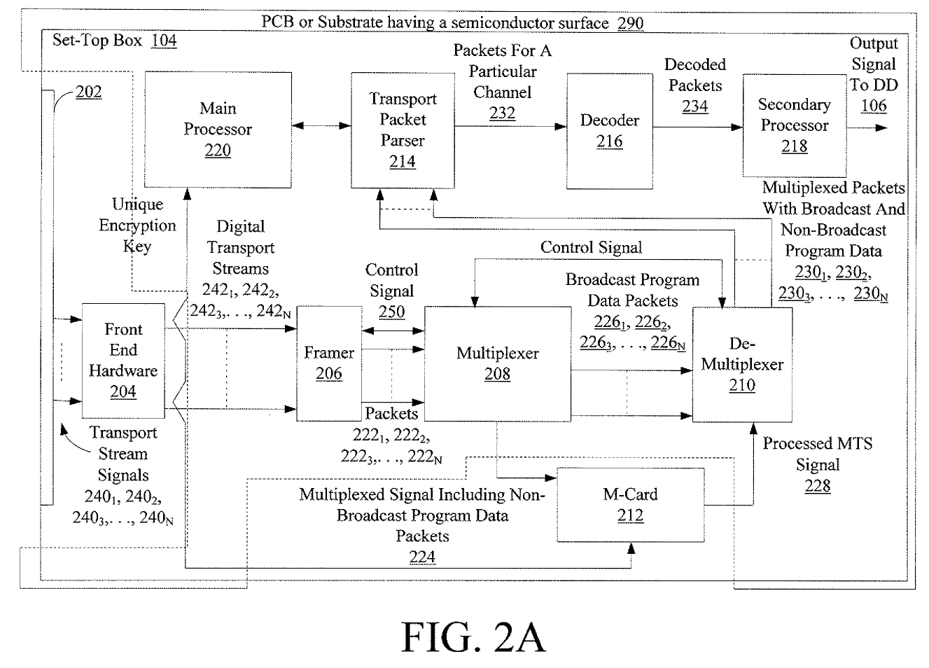

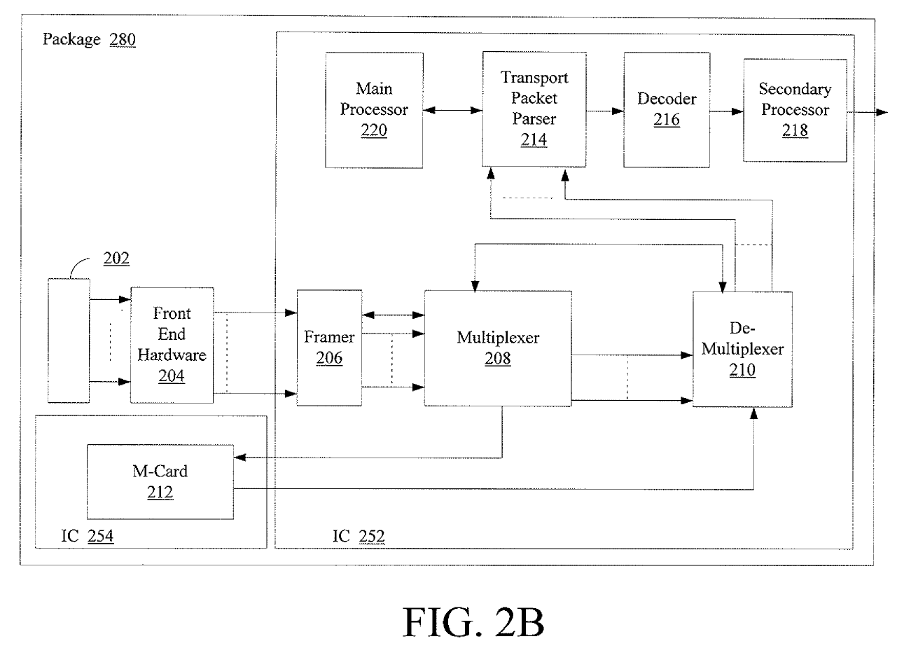

Referring now to FIG. 2A, there is provided a more detailed block diagram of the STB 104 according to an embodiment of the present invention. The STB 104 is configured to process received transport streams to obtain content that is subsequently displayed on the display device 106. As such, the STB 104 includes a system interface 202, front end hardware 204, a framer 206, a multiplexer 208, a multi-stream bi-directional cable card (also referred to herein as an “M-Card”) 212, and a demultiplexer 210. The STB 104 also includes a main processor 220, a transport packet parser 214, a decoder 216, and a secondary processor 218. Each of the components 206, 208, 210, 214, 216, 218, 220 are shown disposed on a substrate 290. The substrate 290 can include, but is not limited to, a printed circuit board (PCB), a printed wiring board (PWB), and any other substrate having a semiconductor surface. The substrate 290 may also include various elements therein and/or layers thereon. These can include barrier layers, other dielectric layers, device structures, active elements and passive elements including source regions, drain regions, bit lines, bases, emitters, collectors, conductive lines, conductive vias, etc. Moreover, the invention can be used in a variety of processes including bipolar, CMOS, BiCMOS and MEMS.

Although the front end hardware 204 and the M-Card 212 are shown coupled to the substrate 290, embodiments of the present invention are not limited in this regard. For example, embodiments of the M-Card 212 can comprise an M-Card disposed on a substrate having a semiconductor surface. Also, embodiments of the present invention can comprise a package 280 including one or more integrated circuits (ICs) 252, 254 (as shown in FIG. 2B). A first IC 252 comprises a signal processing device 212 (shown as an MCard in FIG. 2B). A second IC 254 comprises components 206, 208, 210, and 214-220 (as shown in FIG. 2B). Embodiments of the present invention are not limited in this regard. Notably, the components 202-220 are generally known to those having ordinary skill in the art and may be commercially available.

Referring again to FIG. 2A, the system interface 202 is configured to receive transport streams from TS sources 102₁, . . . , 102_{N} (shown in FIG. 1). The system interface 202 is coupled to the front end hardware 204. The front end hardware 204 is configured to receive the transport stream signals 240₁, 240₂, 240₃, . . . , 240_{N} (serially or in parallel) from the system interface 202. The front end hardware 204 is also configured to transform the transport streams into digital transport streams 242₁, 242₂, 242₃, . . . , 242_{N}. The front end hardware 204 can include, but is not limited to, tuners, modulators (e.g., Quadrature Amplitude Modulation modulators), filters, amplifiers, and analog-to-digital converters. The front end hardware 204 is further configured to communicate the digital transport streams 242₁, 242₂, 242₃, . . . , 242_{N} (serially or in parallel) to the framer 206.

The framer 206 is configured to process the digital transport streams 242₁, 242₂, 242₃, . . . , 242_{N} for detecting frames or identifying packets contained therein. The framer 206 is communicatively coupled to multiplexer 208. Subsequent to detecting the frames or identifying the packets, the framer 206 communicates (serially or in parallel) the packets 222₁, 222₂, 222₃, . . . , 222_{N} to the multiplexer 208. More particularly, the framer 206 writes all or a portion of the packets 222₁, 222₂, 222₃, . . . , 222_{N} (serially or in parallel) to a memory device (not shown) of the multiplexer 208. The framer 206 also communicates control signals 250 to and from the multiplexer 208.

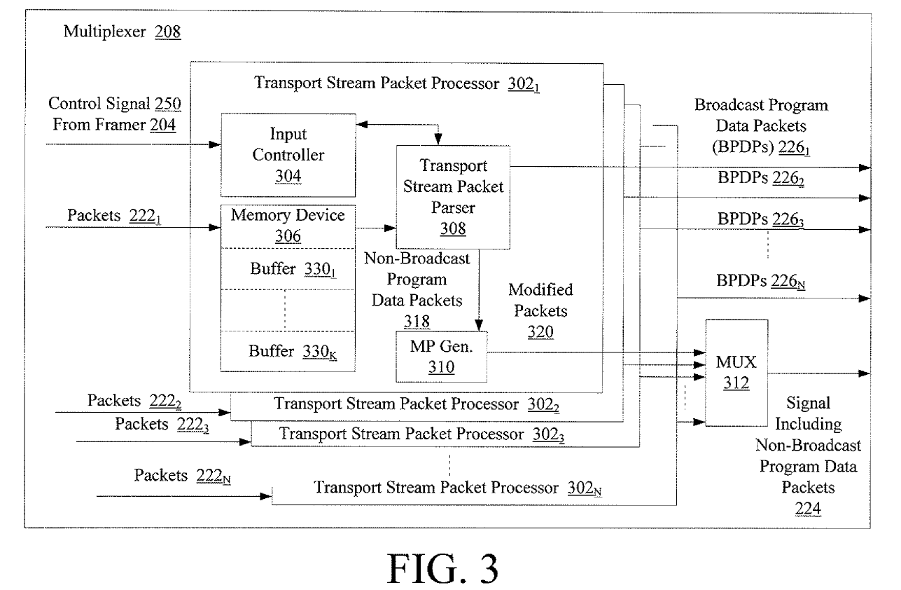

The multiplexer 208 will be described in detail below in relation to FIG. 3. However, it should be understood that the multiplexer 208 is configured to parse each of the transport streams into a plurality of component parts. The component parts are defined by the broadcast program data packets and the non-broadcast program data packets. The multiplexer 208 is also configured to form modified packets (not shown) by adding a header to the non-broadcast program data packets. The header can include, but is not limited to, a Multiplexed Transport Stream (MTS) header. MTS headers are well known to those having ordinary skill in the art, and therefore will not be described herein. However, it should be understood that the MTS header generally includes data (such as a source address, a destination address, control information, and timing information) that is needed for a successful transmission to the M-Card 212. Generally, the MTS header is added to a packet for purposes of identifying to which transport stream signal the packet belongs. The multiplexer 208 is further configured to multiplex the non-broadcast program data packets together to form a multiplexed signal 224 including the non-broadcast program data packets.

As shown in FIG. 2A, the multiplexer 208 is communicatively coupled to the M-Card 212 and the demultiplexer 210. The multiplexer 208 can communicate the broadcast program data packets 226₁, 226₂, 226₃, . . . , 226_{N} to the demultiplexer 210. The multiplexer 208 can also communicate control signals to and from the demultiplexer 210. The multiplexer 208 can further communicate the multiplexed signal 224 to the M-Card 212 for further processing. M-Cards are well known to those having ordinary skill in the art, and therefore will not be described herein. However, it should be understood that the M-Card 212 is generally configured to process the multiplexed signal 224 for decrypting the data contained therein.

The M-Card 212 is also configured to re-encrypt the decrypted data using at least one encryption key that is unique to the STB 104. In this regard, it should be understood that the M-Card 212 is communicatively coupled to the main processor 220. The main processor 220 provides the unique encryption key(s) to the M-Card 212. Encryption keys are well known to those having ordinary skill in the art, and therefore will not be described herein. However, it should be understood that the unique encryption key(s) and re-encryption process collectively ensure that the data contained in the multiplexed signal 224 will be securely retained within the STB 104.

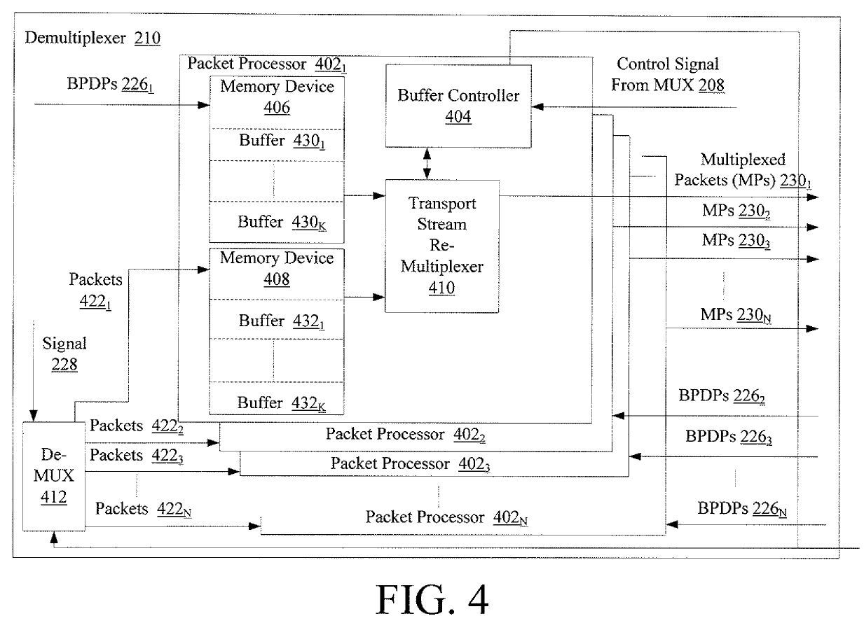

The M-Card 212 is also communicatively coupled to the demultiplexer 210. The M-Card 212 provides the signal 228 including packets containing the re-encrypted data to the demultiplexer 210. The demultiplexer 210 will be described in detail below in relation to FIG. 4. However, it should be understood that the demultiplexer 210 is generally configured for demultiplexing the signal 228 to obtain the non-broadcast program data packets contained therein. The demultiplexer 210 is also generally configured to multiplex the non-broadcast program data packets obtained from the signal 228 and the broadcast data packets 226₁, 226₂, 226₃, . . . , 226_{N} together to form at least one multiplexed packets 230₁, 230₂, 230₃, . . . , 230_{N}.

The demultiplexer 210 is communicatively coupled to the transport packet parser 214. The demultiplexer 210 is configured to communicate one or more multiplexed packets 230₁, 230₂, 230₃, . . . , 230_{N} to the transport packet parser 214. Transport packet parsers are well known to those having ordinary skill in the art, and therefore will not be described herein. However, it should be understood that the transport packet parser 214 can generally check for which packets it is to receive using a program identifier, select the packets for which it is to receive, temporarily store packets, process the stored packets (to decrypt the data, re-encrypt the data, and/or index the data) and communicate stored packets 232 for a particular channel (e.g., a television channel and a particular downloaded movie) to the decoder 216. As should be understood, an indexing of the data can facilitate certain display device operations (such as a pause operation, a rewind operation, a play operation, and a fast forward operation). The transport packet parser 214 can also generally perform encryption key change operation, clock recovery operations, and other processing operations. As shown in FIG. 2A, the transport packet parser 214 can communicate with the main processor 220 and other processors (not shown) of the STB 104.

The decoder 216 process the packets 232 for decoding the same. The packet decoding is performed to decompress the data contained therein. The decoder 216 also communicates the decoded packets 234 to the secondary processor 218. The secondary processor 218 processes the packets for placing the same in a proper form for communication to a display device (e.g., the display device 106 of FIG. 1).

Referring now to FIG. 3, there is provided a more detailed block diagram of the multiplexer 208 according to an embodiment of the present invention. As shown in FIG. 3, the multiplexer 208 can include at least one transport stream packet (TSP) processor 302₁, 302₃, 302₃, . . . , 302_{N} and a multiplexer 312.

Each of the TSP processors 302₁, 302₃, 302₃, . . . , 302_{N} is generally configured to process packets for a particular transport stream signal 240₁, 240₂, . . . , 240_{N}. For example, the first TSP processor 302, can process packets 226₁, 222₁ for a first transport stream signal 240₁. Similarly, the second TSP processor 302₂ can process packets 226₂, 222₂ for a second transport stream signal 240₂, and so on.

As shown in FIG. 3, each of the TSP processors 302₁, 302₃, 302₃, . . . , 302_{N} can include an input controller 304, a memory device (e.g., a Random Access Memory) 306, a transport stream packet (TSP) parser 308, and a modified packet generator 310. The input controller 304 is communicatively coupled to an external device (e.g., the framer 204 of FIG. 2A) and communicates control signals (e.g., the control signal 250 of FIG. 2A) to and from the external device. The input controller 304 is also communicatively coupled to the TSP parser 308 and communicates control signals to and from the TSP parser 308.

The memory device 306 can generally include one or more buffers 330₁, . . . , 330_{K}. Each buffer 330₁, . . . , 330_{K} is provided to temporarily store a packet received from an external device (e.g., the framer 206 of FIG. 2A). The TSP parser 308 is generally configured to retrieve packets from the memory device 306 and process the same. This packet processing is performed to determine which packets include broadcast program data and which packets include non-broadcast program data. The TSP parser 308 is also configured to communicate the broadcast program data packets 226₁, 226₂, 226₃, . . . , 226_{N} (i.e., the packets determined to include broadcast program data) to an external device (e.g., the demultiplexer 210 of FIG. 2A). The TSP parser 308 is also configured to communicate non-broadcast program data packets 318 (i.e., the packets determined to include non-broadcast program data) to the modified packet (MP) generator 310.

The MP generator 310 is configured to receive the non-broadcast program data packets 318 from the TSP parser 308. The MP generator 310 is configured to form modified packets 320 by adding a header to each of the non-broadcast program data packets 318. As noted above, this header can include, but is not limited to, data (such as a source address, a destination address, control information, and timing information) that is needed for a successful transmission of the MP packets 320 to an external device (e.g., the M-Card 212 of FIG. 1).

The MP generator 310 is communicatively coupled to the multiplexer 312. Multiplexers are well known to those having ordinary skill in the art, and therefore will not be described herein. However, it should be understood that the multiplexer 312 is generally configured for multiplexing the MP packets 320 together to form a multiplexed signal 224. The multiplexer 312 is also generally configured for communicating the multiplexed signal 224 to an external device (e.g., the demultiplexer 210 of FIG. 2A).

Referring now to FIG. 4, there is provided a more detailed block diagram of the demultiplexer 210 of FIG. 2A according to an embodiment of the present invention. As shown in FIG. 4, the demultiplexer 210 can generally include a demultiplxer 412 and at least one packet processor 402₁, 402₂, 402₃, . . . , 402_{N}. The demultiplexer 412 is configured to receive the signal 228 from an external device (e.g., the M-Card 212 of FIG. 2A). The demultiplexer 412 is also configured to demultiplex the signal 228 to obtain the packets 422₁, 422₂, 422₄, . . . , 422_{N} contained therein and communicate the same to the packet processors 402₁, 402₂, 402₃, . . . , 402_{N}, respectively.

Each of the packet processors 402₁, 402₂, 402₃, . . . , 402_{N} is generally configured to process packets for a particular transport stream signal 240₁, 240₂, . . . , 240_{N}. For example, the first TSP processor 402₁ can process packets 226₁, 422₁ for a first transport stream signal 240₁. Similarly, the second TSP processor 402₂ can process packets 226₂, 422₂ for a second transport stream signal 240₂, and so on.

As shown in FIG. 4, each of the packet processors 402₁, 402₂, 402₃, . . . , 402_{N} can include a buffer controller 404, at least one memory device (e.g., Random Access Memories) 406, 408, and a transport stream (TS) remutliplexer 410. The buffer controller 404 is configured to communicate control signals to and from an external device (e.g., the multiplexer 208 of FIG. 2A). The buffer control 404 can control the TS remutliplexer 410 and the demultiplexer 412.

The memory device 406 can generally include one or more buffers 430₁, . . . , 430_{K}. Each buffer 430₁, . . . , 430_{K} is provided to temporarily store a broadcast program data packet received from an external device (e.g., the multiplexer 208 of FIG. 2A). Similarly, the memory device 408 can generally include one or more buffers 432₁, . . . , 432_{K}. Each buffer 432₁, . . . , 432_{K} is provided to temporarily store a broadcast program data packet received from the demultiplexer 412. Each of the memory devices 406, 408 is communicatively coupled to the TS remultiplexer 410.

The TS remultiplexer 410 is configured to retrieve packets from the memory devices 406, 408. Multiplexers are well known to those having ordinary skill in the art, and therefore will not be described herein. However, it should be understood that the TS remultiplexer 410 is generally configured for multiplexing the broadcast program data packets 226₁ and non-broadcast program data packets 422₁ together to form respective multiplexed packets 230₁, 230₂, 230₃, . . . , 230_{N}. The TS remultiplexer 410 is also generally configured for communicating the respective multiplexed packets 230₁, 230₂, 230₃, . . . , 230_{N} to an external device (e.g., the transport packet parser 214 of FIG. 2A).

The following FIGS. 5A-5C and accompanying text illustrate a method 500 according to an embodiment of the invention for processing data packets. It should be appreciated, however, that the method 500 disclosed herein is provided for purposes of illustration only and that embodiments of the present invention are not limited solely to the method shown.

Referring now to FIGS. 5A-5C there is provided a flow diagram of an example of a method 500 for processing data packets according to an embodiment of the present invention. As shown in FIG. 5A, the method 500 starts at step 502 and continues with step 504. In step 504, a plurality of transport stream signals (e.g., signals 240₁, 240₂, . . . , 240_{N} of FIG. 2A) are received at an STB (e.g., the STB 104 of FIG. 1). Thereafter, step 506 is performed where each of the transport stream signals is processed to form digital transport streams (e.g., digital transport streams 242₁, 242₂, . . . , 242_{N} of FIG. 2A). This signal processing can be performed by front end hardware (e.g., front end hardware 204 of FIG. 2A) of the STB.

In step 508, packets (e.g., packets 222₁, 222₂, . . . , 222_{N} of FIG. 2A) are identified in each of the digital transport streams. The packet identification can be performed by a framer (e.g., the framer 206 of FIG. 2A) of the STB. Upon identifying the packets, step 510 is performed where the packets for each of the digital transport streams are temporarily stored. The packets can be stored in buffers (e.g., buffers 330₁, . . . , 330_{N} of FIG. 3) of a multiplexer (e.g., the multiplexer 208 of FIGS. 2A-2B and 3) included within the STB. In step 512, it is determined which packets are broadcast program data packets (e.g., packets 226₁, 226₂, 226₃, . . . , 226_{N} of FIG. 2A) and which packets are non-broadcast program data packets (e.g., packets 318 of FIG. 3). This determination can be made by a transport stream packet parser (e.g., the TSP parser 308 of FIG. 3). After the determination is made, the method 500 continues with step 514.

In step 514, the broadcast program data packets are temporarily stored and used in a remulitplex operation to form multiplexed packets. The broadcast program data packets can be temporarily stored in a demultiplexer (e.g., the demultiplexer 210 of FIG. 2A and FIG. 4) of the STB. For example, the broadcast program data packets can be temporarily stored in buffers (e.g., buffers 430₁, . . . , 430_{K} of FIG. 4) of the demultiplexer. Embodiments of the invention are not limited in this regard. Step 514 can also involve communicating the multiplexed packets to a single transport packet parser (e.g., the TP parser 214 of FIG. 2A) of the STB.

After completing step 514, the method 500 continues with step 516. In step 516, the non-broadcast program data packets are processed to form modified packets. Step 516 can involve adding headers (e.g., MTS headers) to each of the packets. Packet headers are well known to those having ordinary skill in the art, and therefore will not be described herein. Step 516 can be performed by a modified packet generator (e.g., the MP generator 310 of FIG. 3) of the muiltplexer. Thereafter, step 518 is performed where a multiplexed signal (e.g., the multiplexed signal 224 of FIG. 2A) is formed using the modified packets. Step 518 can further involve communicating the multiplexed signal to an external device, such as an M-Card (e.g., the M-Card 212 of FIGS. 2A and 3) or other signal processing device. M-Cards are well known to those having ordinary skill in the art, and therefore will not be described herein. In step 520, the multiplexed signal is processed to decrypt the non-broadcast program data contained therein. Step 520 can be performed by the external device, i.e., a signal processing device (e.g., the M-Card 212 of FIG. 2A). Upon completing step 520, the method 500 continues with step 522 of FIG. 5B.

Referring now to FIG. 5B, step 522 involves further processing the multiplexed signal to re-encrypt the non-broadcast program data contained therein. Step 522 can be performed by a signal processing device (e.g., the M-Card 212 of FIG. 2A). The re-encryption can be performed using an encryption key that is unique to the STB. One can appreciate that the re-encryption process ensures that the non-broadcast program data can be temporarily stored securely in the STB. Subsequent to completing step 522, step 524 is performed where the processed signal is demultiplexed to obtain the non-broadcast program data packets (e.g., the packets 422₁, 422₂, 422₃, . . . , 422_{N} of FIG. 4) for each of the digital transport streams. Thereafter, the non-broadcast program data packets are temporally stored in step 526. The non-broadcast program data packets can be stored in a demultiplexer (e.g., the demultiplexer 210 of FIG. 2A and FIG. 4) of the STB. More particularly, the non-broadcast program data packets can be stored in buffers (e.g., the buffers 432₁, . . . , 432_{N} of FIG. 4) of the demultiplexer. The non-broadcast program data packets are stored so that they can be used in a subsequent remultiplex operation. The remutliplex operation will be described below in relation to the next step 528.

Step 528 generally involves performing remultiplex operations to form a plurality of multiplexed packets (e.g., the multiplexed packets 230₁, 230₂, 230₃, . . . , 230_{N} of FIG. 2A and FIG. 4) with broadcast and non-broadcast program data packets. Step 528 can involve using the non-broadcast program data packets temporarily stored in buffers in the previous step 526. Step 528 can also involve using broadcast program data packets. In such a scenario, the packets are multiplexed in a sequential or non-sequential order defined by the order in which the packets were received at the STB.

After completing step 528, the method 500 continues with step 530. In step 530, the multiplexed packets formed in step 528 are communicated to a single transport packet parser (e.g., the TP parser 214 of FIG. 2A) of the STB. At the transport packet parser, step 532 is performed where the multiplexed packets are processed to obtain the broadcast and non-broadcast program data packets contained therein. Steps 534 and 536 are also performed at the transport packet parser. Step 534 generally involves storing the broadcast and non-broadcast program data packets for subsequent processing. Step 536 generally involves generating and storing an index table for the broadcast and non-broadcast program data packets. Index tables are well known to those having ordinary skill in the art, and therefore will not be described herein. Thereafter, the method 500 continues with step 538 of FIG. 5C.

Referring now to FIG. 5C, step 538 generally involves receiving a request for packets containing program data associated with a particular channel (e.g., a TV channel or an input/output channel), a particular type of content (e.g., a downloaded movie), or a particular event. After receiving the request for data, step 540 is performed where the program data contained in the packets is optionally decrypted. Step 540 can involve using a decryption key that is unique to the STB. Thereafter, the packets are decoded in step 542 for decompressing the data contained therein. Step 542 can be performed by a decoder (e.g., the decoder 216 of FIG. 2A) of the STB. Step 542 can also involve communicating the decoded packets to a packet processor (e.g., the secondary processor 218 of FIG. 2A). At the packet processor, step 544 is performed where the packets are processed to form an output signal that is to be communicated to a display device (e.g., the display device 106 of FIG. 1). In step 546, the output signal is communicated to the display device. Subsequently, step 548 is performed where the output signal is received at the display device. Step 548 can also involve displaying content defined by the program data contained therein. Thereafter, step 550 is performed where the method 500 returns to step 502 or subsequent processing is resumed.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A method for processing a plurality of transport streams including a plurality of broadcast program data packets containing broadcast program data and a plurality of non-broadcast program data packets comprising non-broadcast program data, comprising:
multiplexing at least a portion of the plurality of non-broadcast program data packets together to form a first signal;
processing the first signal to generate a second signal comprising re-encrypting at least a portion of the non-broadcast program data to form re-encrypted non-broadcast program data;
demultiplexing the second signal to obtain at least one data packet therefrom including the re-encrypted non-broadcast program data; and
multiplexing the data packet and at least one of the plurality of broadcast program data packets together to form at least one multiplexed packet.

2. The method according to claim 1, further comprising parsing each of the plurality of the transport streams into a plurality of component parts prior to forming the first signal, wherein each of the plurality of component parts is defined by the plurality of broadcast program data packets or the plurality of non-broadcast program data packets.

3. The method according to claim 2, further comprising separating the component parts into component parts defined by the plurality of broadcast program data packets and component parts defined by the plurality of non-broadcast program data packets prior to forming the first signal.

4. The method according to claim 1, further comprising receiving the plurality of transport streams at a packet-based electronic communication device.

5. The method according to claim 1, further comprising receiving the plurality of transport streams at a packet-based optical communication device.

6. The method according to claim 1, further comprising communicating the multiplexed packet to a transport packet parser of a packet-based communication device.

7. An electronic system, comprising:
a first multiplexer for multiplexing at least a portion of a plurality of non-broadcast program data packets together to form a first signal, the plurality of non-broadcast program data packets comprising non-broadcast program data;
a signal processing device coupled to the first multiplexer for processing the first signal to generate a second signal by re-encrypting at least a portion of the non-broadcast program data to form re-encrypted non-broadcast program data;
a demultiplexer coupled to the signal processing device for demultiplexing the second signal to obtain at least one data packet therefrom including the re-encrypted non-broadcast program data; and
a second multiplexer coupled to the demultiplexer for multiplexing the data packet and at least one of a plurality of broadcast program data packets together to form at least one multiplexed packet, wherein the broadcast program data packet comprises broadcast program data.

8. The electronic system according to claim 7, further comprising at least one framer coupled to the first multiplexer for parsing each of a plurality of transport streams into a plurality of component parts defined by the plurality of broadcast program data packets and the plurality of non-broadcast program data packets.

9. The electronic system according to claim 8, wherein the first multiplexer includes a packet parser for separating the component parts into component parts defined by the plurality of broadcast program data packets and component parts defined by the plurality of non-broadcast program data packets prior to forming the first signal.

10. The electronic system according to claim 7, wherein the electronic system is a packet-based electronic communication system or a packet-based optical communication system.

11. The electronic system according to claim 7, further comprising a package having a first and second integrated circuit coupled together, said first integrated circuit comprising the signal processing device and the second integrated circuit comprising the first multiplexer, the demultiplexer, and the second multiplexer.

12. The electronic system according to claim 7, further comprising a transport packet parser coupled to the second multiplexer for processing the multiplexed packet.

13. The electronic system according to claim 7, wherein the signal processing device is a multi-stream bidirectional cable card.

14. An integrated circuit, comprising:
a substrate having a semiconductor surface;
a first multiplexer disposed on the substrate for multiplexing at least a portion of a plurality of non-broadcast program data packets together to form a first signal, the plurality of non-broadcast program data packets comprising non-broadcast program data;
a demultiplexer disposed on the substrate for demultiplexing a second signal including the non-broadcast program data that has been re-encrypted to obtain at least one data packet therefrom; and
a second multiplexer coupled to the demultiplexer for multiplexing the data packet and at least one of a plurality of broadcast program data packets together to form at least one multiplexed packet;
wherein the second multiplexer is disposed on the substrate and the broadcast program data packets contain broadcast program data.

15. The integrated circuit according of claim 14, further comprising a signal processing device coupled to the first multiplexer for processing the first signal to generate the second signal by decrypting the non-broadcast program data and re-encrypting the non-broadcast program data, wherein the signal processing device is disposed on the substrate.

16. The integrated circuit according to claim 14, further comprising a framer coupled to the first multiplexer for parsing each of a plurality of transport streams into a plurality of component parts defined by the plurality of broadcast program data packets and the plurality of non-broadcast program data packets.

17. The integrated circuit according to claim 16, wherein the first multiplexer is coupled to the framer for separating the component parts into component parts defined by the plurality of broadcast program data packets and component parts defined by the plurality of non-broadcast program data packets prior to forming the first signal.

18. The integrated circuit according to claim 14, further comprising a transport packet parser disposed on the substrate and coupled to the second multiplexer for processing the multiplexed packet.
